(19) United States
(12) Patent Application Publication
(10) Pub. No.: US 2013/0332108 A1
(43) Pub. Date: Dec. 12, 2013

(54) EMBEDDED HARDWARE STATE MACHINE FOR CONTEXT DETECTION INTEGRATED WITH A SENSOR CHIP

(71) Applicant: Parin Patel, San Francisco, CA (US)

(72) Inventor: Parin Patel, San Francisco, CA (US)

(73) Assignee: APPLE INC., Cupertino, CA (US)

(21) Appl. No.: 13/494,907

(22) Filed: Jun. 12, 2012

(51) Int. Cl. G01C 22/00; G06F 15/00

(52) U.S. Cl. 702/160

(57) ABSTRACT

Hardware state machine is embedded with sensing element to generate movement context values and context information. Mobile device includes applications processor (AP), data storage, and sensor integrated circuit (IC) package. Data storage includes operating system (OS), and an application program to display a step count. Sensor IC package includes sensing element, analog-to-digital converter (ADC), embedded hardware state machine, and communications interface. Sensing element provides a sensor signal indicating the mobile device's movement. ADC samples the sensor signal. Hardware state machine filters the sampled sensor data, matches the filtered sensor data with one of several predetermined sensor data patterns (e.g. recognized pattern), and then generates a context value, e.g. walking, and a context information, e.g., step count, based on the recognized pattern. The context value and the context information are then provided via the communication interface to the OS (running on the AP.) Other embodiments are also described.

### FIELD

Embodiments of the invention relate generally to the field of context detection by a mobile device, and more particularly, to methods and apparatuses using an embedded hardware state machine that performs context detection and is integrated with a sensor chip.

### BACKGROUND

Pedometers, often referred to as step-counters, are a popular portable electronic device used as an aid to everyday exercise. By counting the number of steps that the user takes, based on detecting forces using an accelerometer the pedometer allows to the user to keep track of walking or running distances covered and thus motivates the user in his exercise routines. While earlier versions of pedometers were implemented as a separate device that the user attached around his waist, the current versions of pedometers may be implemented as software applications in multi-function personal mobile devices such as music players and smartphones.

However, certain multifunction portable wireless communication devices such as smartphones, also referred to as mobile devices, comprise a main applications processor to run multi-threaded or concurrent program execution operating systems, and the pedometer software application runs on such an operating system. Since the mobile devices are battery-operated, power management is imperative. One disadvantage of the pedometer software application is that it needs to be executed by the main applications processor which consumes a significant amount of power.

### SUMMARY

Methods and apparatuses that use a hardware state machine that performs context detection and is integrated with a sensor chip are described herein.

It has been found that, a significant amount of power may be consumed when a mobile device's application processor responds to an interrupt from a sensor, reads the sampled data from the sensor chip's communication interface and makes this data available to an application when considering that a pedometer application needs to obtain the sensor data and perform signal processing repeatedly for example at least once every tenth of a second in order to provide an adequate step count to the user.

More specifically, in a multi-threaded system or concurrent program execution, the application processor needs to execute through a stack of operating system abstraction layers before providing data from the sensor to an application. In the case of a pedometer application, this movement through the software abstraction layer stack may unduly increase power consumption, because a typical pedometer application will process each raw sensor input using the application processor. Accordingly, it is currently difficult for an application to compute the “context” of the mobile device in which it is running, e.g. to compute a user's steps in real-time, due to the loss of synchronization between the application and the sensor chip.

In one embodiment of the invention, a sensor integrated circuit (IC) includes a sensor, an analog to digital converter (ADC), a hardware state machine and a communications interface. The sensor integrated circuit may be a single chip that is in its own separate IC package. A sensor element detects its movement as a sensor signal which fed to the ADC. The sensor element may be, for example, a gyroscope and/or an accelerometer, in the form of a microelectromechanical system (MEMS). The ADC samples the sensor signal and provides a stream of sensor data to the hardware state machine. The latter maybe integrated in the sensor IC, and can be embedded in the sense that it performs a specific function (movement context detection) and is part of a mobile multi-function device. It filters the sampled sensor data from the ADC and processes it to match filtered sensor data with one of several predetermined sensor data patterns (i.e., the recognized pattern). The predetermined sensor data patterns may be stored in a local data storage included in the sensor IC which is accessed by the state machine. The predetermined sensor data patterns may include thresholds, counters, timers between thresholds, etc. . . . The hardware state machine may generate result information, also referred to as a context event or context information, based on the recognized pattern. The communication interface may make the context information available to an external microprocessor on which an application is running.

When the sensor IC is used as part of a mobile device, the predetermined sensor data patterns may include patterns that indicate movement contexts such as, for example, motionless, falling, shaking, walking, jumping, running, and driving. The context information that is generated for the movement context of walking may include a step count that is provided by the communication interface to the application. The application may then display on a graphical user interface, or audibilize, the following information: the step count, distance travelled by the user (as converted from the step count), the speed at which the user travelled, and/or the number of calories that the user has expended.

Another embodiment is a method of using an embedded hardware state machine that performs context detection. A sensor element detects movement and in response outputs a sensor signal which is fed to an ADC. The ADC samples the sensor signal and provides the sampled sensor data to an on-chip hardware state machine. The hardware state machine filters the sampled sensor data and matches the filtered sensor data with one of several predetermined sensor data patterns (i.e., the recognized pattern). The predetermined sensor data patterns, which are associated with respective movement contexts, may be stored in on-chip data storage which is accessed by the hardware state machine. The hardware state machine may generate result information, also referred to as context information or a context event, based on the recognized pattern, and the communication interface may provide the context information to an external microprocessor on which an application is running. The ADC, the sensor, the hardware state machine, the local data storage and the communication interface may be on the same sensor integrated circuit (IC) chip, or in the same IC package.

The above summary does not include an exhaustive list of all aspects of the present invention. It is contemplated that the invention includes all systems, apparatuses and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 illustrates an example of a mobile device in use.

FIG. 2 shows a block diagram of the mobile device.

FIG. 3 shows a block diagram of an example sensor integrated circuit (IC).

FIG. 4 shows a flow diagram of an example method of using an embedded hardware state machine that performs context detection.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

Certain terminology is used in the following description to describe features of the invention. For example, the terms “module” or “logic” are representative of hardware and/or software configured to perform one or more functions. For instance, examples of “hardware” include, but are not limited or restricted to an integrated circuit such as a processor (e.g., microprocessor, application specific integrated circuit, a digital signal processor, a micro-controller, system-on-a-chip, etc.). A “hardware state machine” as used here refers to hardwired logic configured with operational states required to solve a specific problem or perform a specific task, in the manner of a finite state machine. The hardware state machine may include, for instance, simple logic gates, multiplexers, timers, counters, and thresholds. Given the function of the state machine is bounded the hardware state machine consumes low amounts of power.

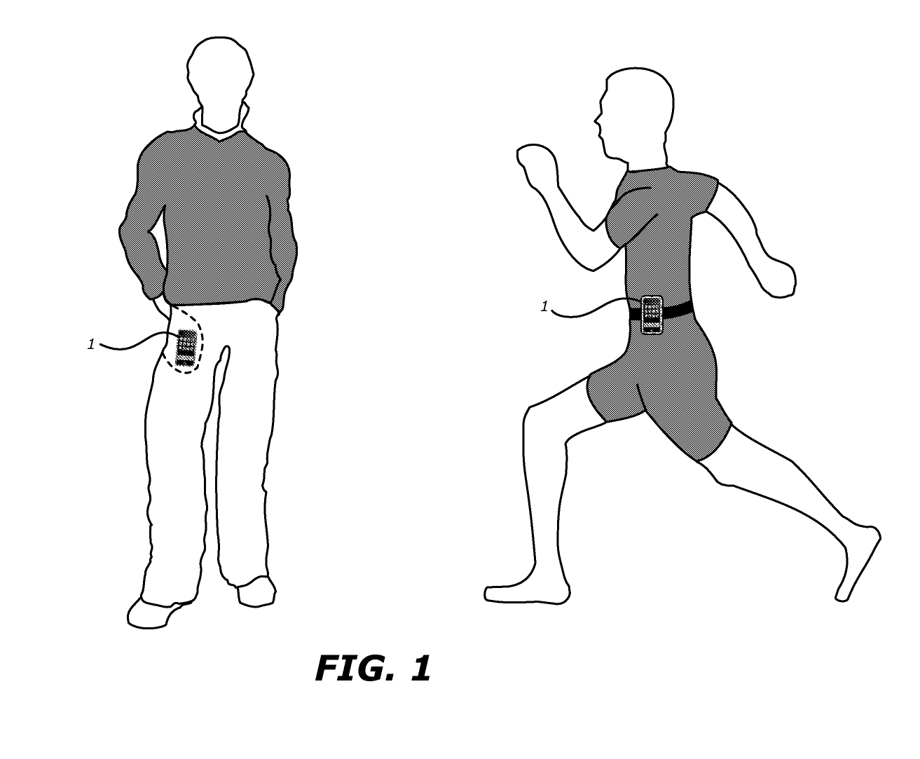

FIG. 1 illustrates an example of a mobile device in use. The mobile device 1 may detect the movements of a user that include, for example, a step, walking, running, or driving. As illustrated in FIG. 1, the user may, for example, place the mobile device 1 in his pocket or attach the mobile device 1 around to his waist. While being carried on a user's person, the mobile device 1 may detect the movements of the user and display the particular context information of the user or mobile device, as information on a user interface. In some embodiments, the mobile device 1 while being carried in a user's pocket may detect steps taken by the user and display the number of steps to the user.

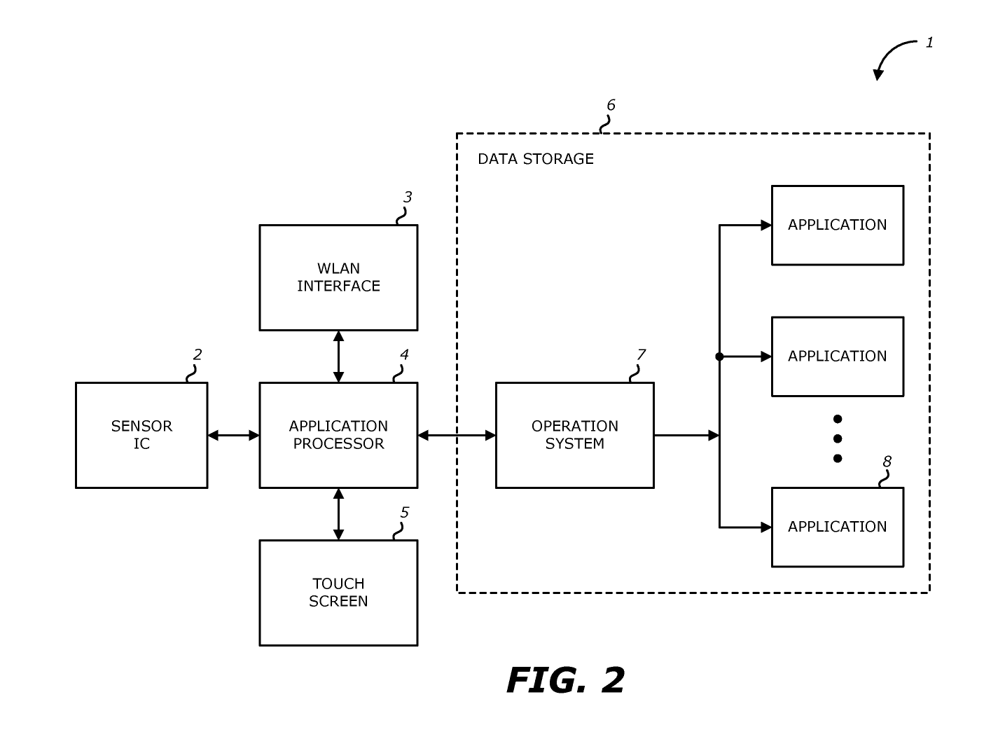

FIG. 2 shows a block diagram of an example of the mobile device that has an embedded hardware state machine integrated with a sensor chip and that performs context detection. For example, the mobile device 1 may be a smartphone such as an iPhone™ device, a personal digital media player such an iPod™ device, a tablet computer such as an iPad™ device, or a notebook computer such as a MacBook Air device, all of which are from Apple Inc. of Cupertino, Calif.

As illustrated in FIG. 2, the mobile device 1 may include a sensor integrated circuit (IC) 2, an application processor 4, a wireless local area network (WLAN) interface 3, a touch screen interface 5, and data storage 6. The WLAN interface 3 in mobile device 1 may interface with an IEEE 802.11 network (WiFi). The data storage 6 may store therein an operating system 7 and several applications including an application 8 that needs a current movement context of the device 1 (e.g. a pedometer application). In the case where the mobile device 1 has cellular phone functionality, a further wireless communications interface that can link with a cellular terrestrial radio access network is also included. The data storage 6 may contain many applications, such as email, web browser, map, telephony, music player, movie player, etc.

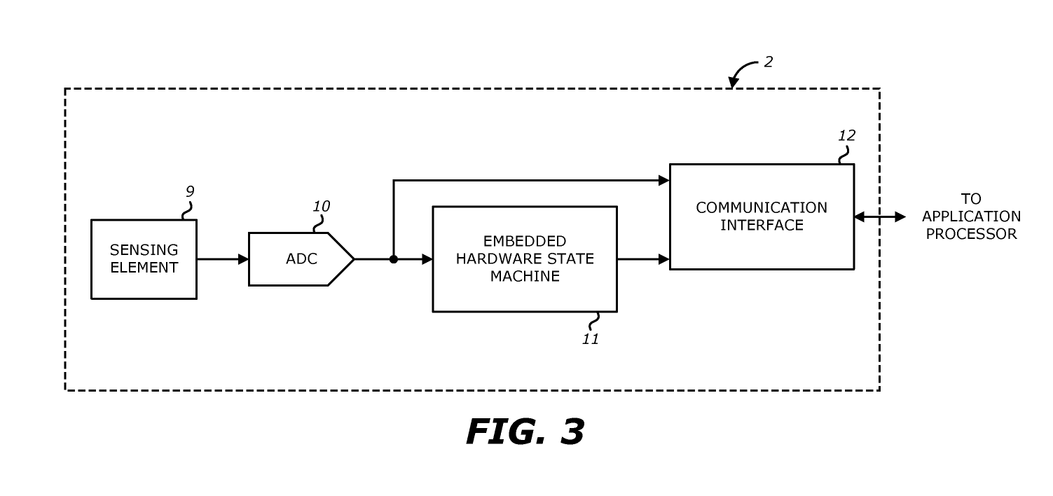

The sensor IC 2 may be a single chip or die that is communicatively coupled to the application processor 4 via a component interconnect bus (e.g., I²C). FIG. 3 shows a block diagram illustrating one embodiment of the sensor IC 2 from FIG. 2. In one embodiment, the sensor IC 2 may include a sensing element 9, an analog-to-digital converter (ADC) 10, an embedded hardware state machine 11 and a communication interface 12.

In one embodiment, the sensing element 9 may be a position, orientation, or movement (POM) sensor such as a gyroscope or an accelerometer, which may be in the form of a microelectromechanical system (MEMS). The sensing element 9 may detect force, movement or changes in orientation of the mobile device 1. For example, the sensing element 9 may be able to detect its movement to determine the components of motion. The components of motion may include: forward (roll axis), vertical (yaw axis), side (pitch axis) and acceleration in the x, y, and z directions. The sensing element 9 provides a sensor signal that represents any one or more such components, to the ADC 10.

The ADC 10 may then sample the sensor signal received from the sensing element 9. In one embodiment, the ADC 10 may then provide the raw sampled sensor data to the communication interface 12. In this embodiment, the operating system 7 in FIG. 1 may convert or process the raw sampled sensor data (obtained through the communication interface 12) using known algorithms, into a context value or context information related to the context value. The context value may be an abstract data type that embodies a movement context meaningful to applications. For example, a context value may refer to a user's motion state and might take values such as sitting, standing, walking or driving. The context information is information that is related to the context value. For example, if a context value indicates walking, the context information related to the walking context value is a step count which may be provided by a pedometer function. Thus, the context value and context information related to the context value has a high level of data abstraction. However, performing the conversion of the raw sampled sensor data into a context value or context information by the operating system 7 and then providing the context value or context information to a requesting application program suffers from delays in reading the sensor IC 2, because the operating system 7 may employ priority based preemptive schedulers where design parameters such as thread priority and time quantum size directly influence performance metrics. The operating system 7 may also assign high priority to the user's foreground process, while forcing other background applications that need to obtain the context value or context information to wait for access to the raw sensor data.

As illustrated in FIG. 3, the ADC 10 may also output the sampled sensor data to the embedded hardware state machine 11. The embedded hardware state machine 11 may convert the sampled sensor data to a context value, by low pass filtering the sampled sensor data from the ADC 10 and then matching the filtered sensor data with one of several predetermined sensor data patterns. Each of the predetermined sensor data patterns indicates a different movement context. The movement contexts may include, for instance, motionless, falling, shaking, walking, jumping, running, and driving. In some embodiments, the sensor IC 2 may also include a local or on-chip data storage to store the predetermined sensor data patterns associated with the movement contexts, respectively. In this embodiment, the local or on-chip data storage is accessed by the embedded hardware state machine 11 to match the filtered sensor data with one of the predetermined sensor data patterns. The one predetermined sensor data pattern which the hardware state machine 11 determines to match with the filtered sensor data is referred to as the recognized pattern. The hardware state machine 11 may then generate context information based on the recognized pattern and provide the context value and/or context information to the communication interface 12. For example, if the recognized pattern for the context value indicates walking, the context value provided to the communication interface 12 may indicate walking and the context information provided to the communication interface 12 may include a step count. Upon receiving at least one of the context value (e.g., walking) and the context information (e.g., step count) from the embedded hardware state machine 11, the communication interface 12 may provide at least one of the context value and the context information to an application 8, via the applications processor 4. In some embodiments, the communication interface 12 may be an Inter-Integrated Circuit (I²C). Each time an update to the context value or the context information is calculated and written to an on-chip register or buffer of the sensor IC 2, the state machine can assert an alert or data ready flag in the communication interface 12, which signals the application processor 4 to read the updated context value or context information.

As shown in the embodiment in FIG. 3, the embedded hardware state machine 11 is embedded onto the sensor IC 2, i.e., “behind” the communication interface 12. This integration of the embedded hardware state machine 11 into the sensor IC 2 provides the advantage that the low level signal processing of the sampled sensor data required to calculate the context value (e.g., walking) and the context information (e.g., number of steps taken by the user) is performed by the embedded hardware state machine 11, and then context value and context information such as the step count are made available to the application 8 via the communication interface 12. More specifically, a driver in the operating system 7 directly obtains the context value and the context information from the sensor IC 2 and then delivers, in accordance with an application programming interface (API), the context value and the context information to a requesting application. For example, the operating system 7 can be periodically receiving updated context values and context information from the sensor IC 2 and then writing them to a software buffer area that is accessible by the application 8. Given that neither the application 8 nor the operating system 7 perform the signal processing and calculations needed to compute the context value and the context information, this embodiment of the invention provides a solution to the issue of software delay that arises when the application processor 4 is required to work through several layers of operating system abstraction layers to provide the application 8 with the raw sampled data (which it obtains through the communication interface 12 of the sensor IC 2). Accordingly, when neither the application 8 nor the operating system 7 has to obtain the raw sampled sensor data from the sensor IC 2 and then perform calculations and signal processing upon the sampled sensor data in order to compute the context value (e.g., walking) and the context information (e.g., step count), the application 8 is able to expediently use or present a more accurate CDU to the user.

One advantage of using the embedded hardware state machine 11 is that the power consumed by the mobile device 1 is reduced. First, the hardware state machine 11 includes hardwired logic that is limited and bounded in its function, e.g., that of counting steps. Further, the hardware state machine 11 is not a processor that is programmable and as such it does not require as much power as would be required by software running for instance on an applications processor that is performing the same function. In particular, the hardware state machine 11 is matching the filtered sensor data while the applications processor 4 on which the operating system 7 is running is “asleep”; the hardware state machine 11 determines when to “wake up” the application processor 4 and the operating system 7 (e.g., when it recognizes a pattern and can provide the resulting context value or context information to the operating system 7). Therefore, the power consumed by the mobile device is reduced even though the steps are being counted.

An embodiment of the invention may be a machine-readable medium having stored thereon instructions that are part of the operating system 7. A machine-readable medium may include any mechanism for storing or transmitting information in a form readable by a machine (e.g., a computer), such as Compact Disc Read-Only Memory (CD-ROMs), Read-Only Memory (ROMs), Random Access Memory (RAM), and Erasable Programmable Read-Only Memory (EPROM). Referring to FIG. 2, the instructions stored on the machine-readable medium may program the application processor 4 to perform operations including, for instance, waking up from sleep in response to a signal from the sensor IC 2, reading at least one of a movement context value and a movement context information from the sensor IC 2 and writing the at least one of the movement context value and the movement context information to data storage 6. The movement context values and information may also be defined by the stored instructions. In some embodiments, the instructions may include an application programming interface that enables an application 8 to obtain at least one of the context value and the context information from the operating system 7.

The following embodiments of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, etc. The processes are performed by processing logic that comprises hardware (e.g., circuitry, dedicated logic, etc.), software (such as is run on a general-purpose computer system or dedicated machine), or a combination of both.

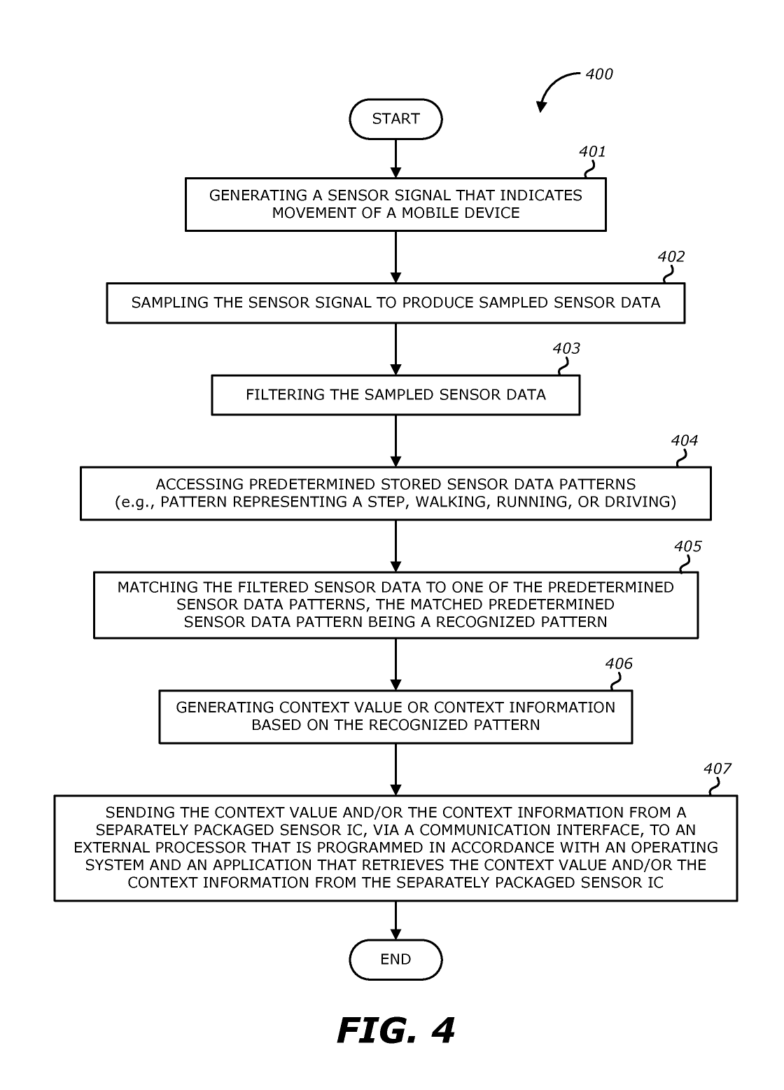

FIG. 4 shows a flow diagram of one embodiment of a method of providing context values and/or context information directly to an operating system, based on a pattern recognized by an embedded hardware state machine that is within a sensor chip. For example, method 400 may be performed in part by the sensor IC 2 of FIG. 3 and in part by the programmed applications processor 4 of FIG. 2.

Method 400 begins with generating a sensor signal indicating movement of a mobile device (Block 401). The movement of the mobile device may include the components of motion for a user wearing the mobile device on his person as illustrated in FIG. 1. At Block 402, the sensor signal is being sampled to produce sampled sensor data. At Block 403, the sampled sensor data sequence is being filtered. At Block 404, predetermined stored sensor data patterns are being accessed from a local data storage (e.g., on-chip with the embedded hardware state machine). The predetermined stored sensor data patterns may be patterns representing, for example, a step, walking, running, or driving. At Block 405, the filtered sensor data is being compared to one of the predetermined stored sensor data patterns to find a match. The matched predetermined stored sensor data pattern may be referred to as the recognized pattern. At Block 406, context value or context information related to the context value based on the recognized pattern is being generated. For example, if the recognized pattern for the context value indicates walking, the context value may include walking and the context information may include a step count (based on accumulating the step events that are detected). At Block 407, at least one of the context value and the context information is being sent from a separately packaged sensor IC to an external processor, where the latter is programmed in accordance with (i) an operating system whose driver program is requesting at least one of the context value and the context information from the sensor IC and (ii) an application that is accessing at least one of the context value and the context information using an API.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

1. A packaged sensor integrated circuit comprising:
a single integrated circuit (IC) package having integrated therein
a sensing element to provide a sensor signal indicative of movement of the IC package;
an analog to digital converter (ADC) coupled to the sensing element to sample the sensor signal;
a hardware state machine to filter the sampled sensor data from the ADC to obtain filtered sensor data, and to match the filtered sensor data with one of a plurality of predetermined sensor data patterns, the matched one of the plurality of predetermined sensor data patterns being a recognized pattern, and to generate context information based on the recognized pattern; and
a communications interface to provide the context information to an external processor.

2. The packaged sensor integrated circuit of claim 1, wherein
the plurality of predetermined sensor data patterns indicate movement contexts including motionless, falling, shaking, walking, jumping, running, and driving.

3. The packaged sensor integrated circuit of claim 1, wherein
the recognized pattern indicates walking and the context information provided by the communication interface includes a step count.

4. The packaged sensor integrated circuit of claim 2, further comprising:
a data storage integrated in the IC package, to store the plurality of predetermined sensor data patterns associated with the plurality of movement contexts, respectively.

5. The packaged sensor integrated circuit of claim 1, wherein the sensing element is one of an accelerometer and a gyroscope.

6. The packaged sensor integrated circuit of claim 1, wherein the communications interface is to provide an external processor with the sampled sensor data in addition to the context information, and wherein the sensing element, the ADC, the state machine, and the communication interface are all integrated on the same chip.

7. A mobile device comprising:
a wireless communications interface;
a display screen;
an applications processor;
a data storage coupled to the applications processor, the data storage to store an operating system, and an application that is to display a step count on the display screen;
a single integrated circuit (IC) package coupled to the application processor, the single IC package having integrated therein
a position, orientation or movement sensing element to provide a sensor signal,
an analog to digital converter (ADC) to sample the sensor signal from the sensing element,
a hardware state machine to (i) filter the sampled sensor data from the ADC, (ii) match the filtered sensor data with one of a plurality of predetermined sensor data patterns, and (iii) generate context information based on a recognized pattern, the matched one of the plurality of predetermined sensor data patterns being the recognized pattern, and
a communication interface to provide the context information to the applications processor.

8. The mobile device of claim 7, wherein
the plurality of predetermined sensor data patterns indicate movement contexts including motionless, falling, shaking, walking, jumping, running, and driving.

9. The mobile device of claim 7, wherein
the recognized pattern indicates walking and the context information provided by the communication interface includes step count.

10. The mobile device of claim 8, wherein the single IC package further comprises:
a data storage integrated in the IC package, to store the plurality of predetermined sensor data patterns associated with the plurality of movement contexts, respectively; and
wherein the hardware state machine is to access the data storage to obtain the plurality of predetermined sensor data patterns.

11. The mobile device of claim 7, wherein the application processor is programmed in accordance with the operating system and the application is to retrieve the context information from the separately packaged sensor IC via the application processor.

12. The mobile device of claim 7, wherein the communication interface is to provide the application processor with the sampled sensor data in addition to the context information, and wherein the sensing element, the ADC, the state machine, and the communication interface are all integrated on the same chip.

13. The mobile device of claim 7, wherein
the application (i) is external to the packaged sensor integrated circuit, (ii) is included in the mobile device, and (iii) displays the step count.

14. A method for operating a sensor integrated circuit, comprising:
generating a sensor signal indicating movement;
sampling the sensor signal to produce a sampled sensor data;
filtering the sampled sensor data;
accessing a plurality of predetermined stored sensor data patterns associated with a plurality of movements of the mobile device, respectively;
matching the filtered sensor data to one of the plurality of predetermined stored sensor data patterns, the matched one of the plurality of predetermined sensor data patterns being a recognized pattern;
generating context information based on the recognized pattern; and
sending the context information from a separately packaged sensor IC, via a communication interface, to an external processor that is programmed in accordance with an operating system and an application that is to retrieve the context information from the separately packaged sensor IC.

15. The method of claim 14, wherein
the plurality of predetermined sensor data patterns indicate movement contexts including motionless, falling, shaking, walking, jumping, running, and driving.

16. The method of claim 14, wherein
the recognized pattern indicates walking and the context information sent to the external processor includes step count.

17. An article of manufacture comprising:
a computer-readable medium having stored therein instructions, that are part of an operating system program of a mobile device, that program an applications processor to read a movement context value from a sensor integrated circuit that is separately packaged than the applications processor, and to then write the context value to storage in the mobile device so as to make the written context value accessible to an application program, wherein the stored instructions also include an application programming interface that enables an application to obtain the context value from the operating system.

18. The article of manufacture of claim 17 wherein the instructions define a plurality of movement context values that can be read from the sensor integrated circuit, including at least two of the group consisting of motionless, falling, shaking, walking, jumping, running, and driving.

19. The article of manufacture of claim 17 wherein the instructions define the movement context value as walking and a context information related to the movement context value as a step count, and wherein the instructions also include the application programming interface that enables the application to obtain the context information from the operating system.

20. The article of manufacture of claim 17, wherein the instructions program the applications processor to wake up from sleep in response to a signal from the sensor integrated circuit and then read the movement context value from the sensor integrated circuit.
